(19) United States
(12) Patent Application Publication
(10) Pub. No.: US 2004/0153340 A1
(43) Pub. Date: Aug. 5, 2004

(54) Method for monitoring telemedicine healthcare services

(76) Inventors: Tilo Christ, Erlangen (DE); Heinz Prihoda, Heroldsberg (DE); Volker Schmidt, Erlangen (DE); Siegfreid Schneider, Erlangen (DE); Hans-Dieter Schull, Weisendorf (DE); Werner Striebel, Schwarzenbruck (DE); Gudrun Zahlmann, Neumarkt (DE)

Correspondence Address: HARNESS, DICKEY & PIERCE, P.L.C., P.O.BOX 8910, RESTON, VA, 20195, US

(21) Appl. No.: 10/480,439

(22) PCT Filed: Jun. 10, 2002
(86) PCT No.: PCT/DE02/02109

(30) Foreign Application Priority Data
Jun. 13, 2001 (DE) 101 28 521.3

(51) Int. Cl. G06F 17/60

(52) U.S. Cl. 705/2

(57) ABSTRACT

The invention relates to a method for automated monitoring of the service quality of at least one person (P1-P8), recording and/or evaluating medical data sets as part of a telemedicine healthcare service. The invention also relates to a method for automated monitoring of the service quality of the person (P1-P8) recording and/or evaluating the medical data sets. The number of medical data sets received and/or evaluated by the person (P1-P8) per time unit or data characterizing the quality of the recordings and/or evaluation of the medical data sets are determined. The number of medical data sets received and/or evaluated by the person P1-P8) and/or the data characterizing the quality of the recordings and/or evaluation is/are compared with predetermined data and the service quantity and/or service quality of person (P1-P8) receiving and/or evaluating the data is calculated.

The invention relates to a method for monitoring telemedical health services, particularly for the quantity and/or quality in which the telemedical health services are provided.

Telemedical health services are understood to mean any types of telemedicine, for example examination of medical data records which have been sent to a service facility for telemedical health services via a communication network, or the online examination of body functions using technical means for the remote transmission of data. Telemedical health services are thus preferably handled entirely using means for the remote transmission of data, from order allocation through performance to delivery of the result.

For the operators of a service facility providing telemedical health services, or of an entire health service chain for telemedical health services which comprises a plurality of service facilities which always have an interest in improving the quality of the health services provided, improving the performance quantity for the service facility or the service chain and improving the execution processes when providing the telemedical health services or at least in maintaining a certain status, it is desirable to be able to ascertain the respective current status in terms of the quality of the health services provided, the performance quantity for the service facility or for the service chain and the process quality level in order to be able to make an assessment and to be able to spot and eliminate weaknesses.

The invention is therefore based on the object of specifying a method for monitoring telemedical health services such that it is possible to check the performance quality and/or performance quantity for a service providing such telemedical health services quickly and without difficulty.

The invention achieves this object by means of a method in accordance with patent claim 1.

On the basis of the inventive method, a data processing facility ascertains the number of medical data records recorded by one or more person(s) recording medical data records per unit time, that is to say per hour, day or week, the recordings of the data records being at least part of a health service which is to be provided. Alternatively or in addition, the data processing facility ascertains data which permit a statement about the quality of the data records recorded by the persons, and compares these data and/or the quantitative service data with prescribed nominal or limit values. From this, the data processing facility derives a rating for the quantitative and/or qualitative performances for each of the persons recording medical data records. In addition, the data processing facility to which recorded medical data records needing to be evaluated are transmitted can alternatively or additionally ascertain how many medical data records are evaluated by one, preferably more, person(s) intended to be evaluating medical data records per unit time, that is to say per hour, day or week, for example, with the evaluation likewise being part of a health service which is to be provided. In addition, the data processing facility can alternatively or additionally ascertain data which permit a statement about the quality of the evaluation of the medical data records by the persons, and compares these data and/or the quantitative performance data with prescribed nominal or limit values. From this, the data processing facility derives a rating for the quantitative and/or qualitative performances for each of the persons evaluating medical data records.

This allows, by way of example, an operator of a service facility for telemedical health services to obtain at any time an overview of the performance quantity and/or performance quality for his service facility, particularly for his staff, and to identify weaknesses not just in relation to the performance of individual persons, but also in the event of an increased occurrence of performance data which differ from prescribed nominal or limit values for various persons in processes.

In one particularly preferred embodiment of the invention, the data processing facility produces a graphic for visualizing the ascertained ratings and also the quantitative and/or qualitative performance data for the persons recording medical data records and/or for the persons evaluating medical data records. The graphic can be used to perform analyses regarding the quantitative and/or qualitative performances of the staff in a service facility for telemedical health service easily and quickly.

In another embodiment of the invention, the rating of the performance quantity and/or of the performance quality for the person recording medical data records and/or for the person evaluating medical data records is taken as a basis for deriving at least one consequence or for proposing a measure. In line with one variant of the invention, the essence of a consequence is that a person recording medical data records is assigned no more patients for recording medical data records if, by way of example, the quality of the recorded data records does not correspond to the prescribed nominal or limit values. By way of example, a measure can consist in training on how data records can be recorded with high quality. In line with another variant of the invention, the essence of a consequence is that a person evaluating medical data records is allocated no more medical data records if the evaluations performed by the person evaluating medical data records do not correspond to the qualitative stipulations, for example. The consequence based on the rating, that is to say the barring of the person, can in this case only be signalled by the data processing facility or can be carried out by the data processing facility. The latter can be done, by way of example, by virtue of the appliance, e.g. a computer which the person uses to evaluate medical data records and to which the medical data records needing to be evaluated by the person are normally sent automatically by the data processing facility, now not being sent any medical data records for evaluation. In this case too, a measure proposed on the basis of the rating can involve training a person to increase the quality of his evaluations.

In one variant of the invention, the person recording medical data records is associated with a first service facility and the person evaluating medical data records is associated with a second service facility, which service facilities form a health service chain. A telemedical health service thus does not need to be provided by a single service facility, but rather can be provided by a plurality of service facilities with a function split.

In line with one variant of the invention, the stipulations for comparing the performances of the persons recording and/or evaluating medical data records are adaptive. The stipulations can be derived from statistical evaluations of the data obtained in the service facility or facilities from a large patient collective. In this case, the stipulations are adapted as the data base changes over time.

Embodiments of the invention make provision for at least some of the service facilities in the health service chain to be arranged at different locations, with the data which are produced in the service facilities and are stored in computers being compiled in a central data processing facility. In this case, the computers in the service facilities are networked to one another and to the central data processing facilities.

In line with another embodiment of the invention, the average processing time for a data record from a person recording medical data records and/or from a person evaluating medical data records is also registered, that is to say how long on average a person recording the medical data records requires to record them and how long on average a person evaluating the data records requires to evaluate them.

In line with one variant of the invention, the quality of the evaluation of medical data records by a person evaluating medical data records is ascertained such that known medical data records which relate to telemedical health services and whose evaluation is known are added purposefully to medical data records awaiting evaluation, the present evaluations of the purposefully added known medical data records are registered, the present evaluations of the known medical data records are compared with the known evaluations of the known medical data records, and the number of present evaluations which differ significantly from the known evaluations of the known medical data records is ascertained.

In line with one variant of the invention, the known evaluations of the known medical data records come from the person evaluating the medical data records himself, i.e. a check is carried out to determine whether the respective person obtains different results for repeated evaluation of a medical record.

In line with another variant, the known evaluations of the known medical data records from the person evaluating medical data records are presented for the first time.

Embodiments of the invention make provision for checking sensitivity and specificity. In the case of sensitivity, this involves using the known medical data records to check how many known medical data records which explicitly indicate an illness or abnormality are recognized as such by the person evaluating medical data records. In the case of specificity, the known medical data records are used to check how many known medical data records which explicitly do not indicate an illness or abnormality are recognized as such by the person.

Variants of the invention involve checking how long a medical appliances used by a service facility is licensed for telemedical health services before its operation needs to be checked, and signalling the status for the check. In this way, medical appliances used by the service facility are also included in the automated monitoring of a service facility's qualitative performances. In line with one variant of the invention, provision is made for the operation of a medical appliance to be disabled when the time for the operating licence of the appliance has been exceeded.

In one refinement of the invention, the medical data records are image data, and, in line with variants of the invention, are ophthalmological image data, mammographical image data, pathological image data or dermatological image data.

In line with further refinements of the invention, the availability of the person recording medical data records and/or of the person evaluating medical data records, the utilization level of the person recording medical data records and/or of the person evaluating medical data records and/or of the appliances used by the persons, the number of health services per unit time, the number of health services which provided no findings, and the number of health services in which medical complications arose, are registered.

An exemplary embodiment of the invention is shown in the appended schematic drawing, in which:

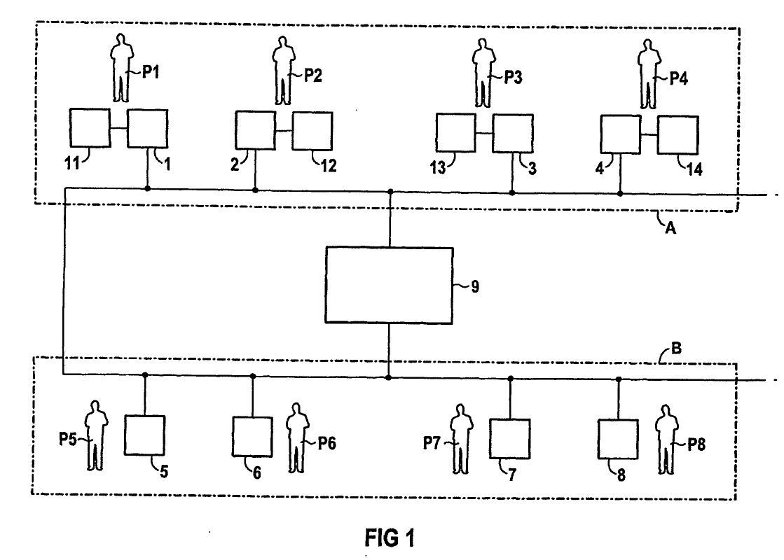

FIG. 1 shows a structure of a health service chain for providing a telemedical health services, and

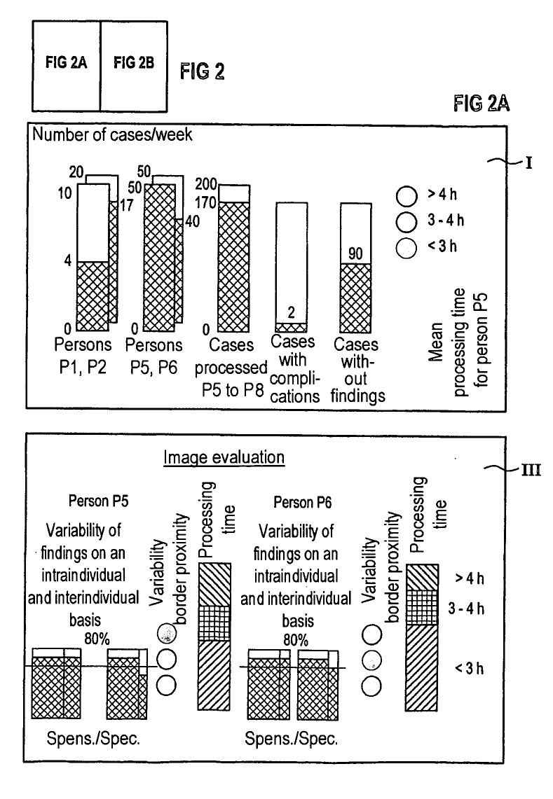

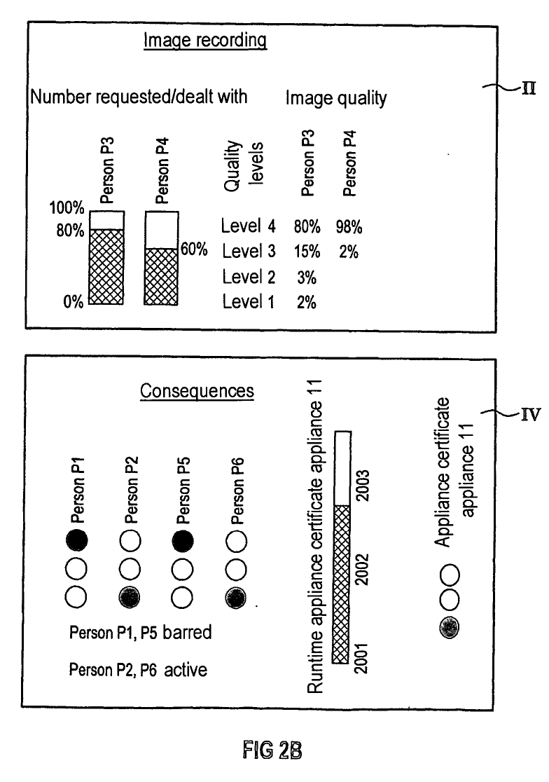

FIG. 2 shows details from a visualization of the quantitative and qualitative performances of parts of the health service chain.

In the case of the present exemplary embodiment, the health service chain shown in FIG. 1 for telemedical health services comprises two service facility A, B and a central data processing facility 9. The service facility A comprises four computers 1 to 4 in the form of PCs (Personal Computers) and the service facility B comprises four computers 5 to 8, likewise in the form of PCs. In the case of the present exemplary embodiment, the central data processing facility 9 and the PCs 1 to 8 are connected to a communication network 10 and can therefore communicate with one another. In the present case, the health service chain specializes in telemedical health services relating to ophthalmology, that is to say the branch of medicine concerned with the eye, and the service facility A at a separate location from the service facility B records medical data records in the form of ophthalmological images which are evaluated in the service facility B.

The PCs 1 to 4 are associated with persons P1 to P4 who work for the service facility A and who record the ophthalmological images, e.g. image data from the fungus of the eye of a patient. For this purpose, diagnostic appliances 11 to 14 are connected to the PCs 1 to 4. The image data records recorded using the appliances 11 to 14 are transmitted to the respective associated PC 1 to 4, which forward the image data records via the communication network 10 to the central data processing facility 9. The communication network can otherwise be a public communication network or else a communication network which has been set up and is operated specially by the health service chain.

The central data processing facility 9 buffer-stores the recorded image data records and distributes them via the communication network 10 to the PCs 5 to 8 in the service facility B, which are associated with persons P5 to P8 who evaluate the image data records, derive medical decisions therefrom and possibly produce a finding.

In the course of operation of the health service chain, the data processing facility 9 respectively registers how many image data records are transmitted from each of the PCs 1 to 4 in the service facility A to the data processing facility 9 per unit time, per week in the case of the present exemplary embodiment, which respectively corresponds to the number of image data records recorded by the persons P1 to P4 per week in the case of the present exemplary embodiment. In this case, the respective processing time is also registered, i.e. the time which one of the persons P1 to P4 requires in order to record an image data record, and the average processing time for an image data record is ascertained for each person P1 to P4.

In addition, the data processing facility 9 checks the quality of each image data record transmitted by first ascertaining characteristic image values, such as the brightness or contrast of an image. The ascertained characteristic image values for the image data records examined are then compared with prescribed image values, and the quality of each image data record is rated at four levels in the case of the present exemplary embodiment. The prescribed image values are generally not static in this case, but rather are constantly adapted. The image values are thus not arbitrarily prescribed image values. Instead, the prescribed image values are derived from the set of recorded images of patients on the basis of statistical evaluations. Since the set of recording images is constantly changing, that is to say the data base from which the stipulations are derived changes, the stipulations normally also change.

In addition, the data processing facility 9 respectively registers how many image data records are evaluated and sent to the data processing facility 9 by each of the PCs 5 to 8 in the service facility B per unit time, per week in the case of the present exemplary embodiment, which respectively corresponds to the number of image data records evaluated by the persons P5 to P8 per week in the case of the present exemplary embodiment. This also involves registering the processing time, i.e. the time which one of the persons P5 to P8 requires in order to evaluate an image data record, and ascertaining the average processing time for evaluating an image data record for each person P5 to P8.

In addition, the data processing facility 9 checks the quality with which the persons P5 to P8 evaluate the image data records by explicitly adding image data records whose evaluations are known, without the knowledge of the persons P5 to P8, to the image data records awaiting evaluation by the persons P5 to P8. In this way, the intraindividual and interindividual variability of the evaluations of each of the persons P5 to P8 is checked. In the case of the present exemplary embodiment, approximately 20% of the image data records transmitted to one of the persons P5 to P8, and the evaluations of said image data records, are known. In 10% of all the image data records presented to one person, the evaluations come from the person himself, which allows the intraindividual variability for the person to be checked. The person P5 thus rates, by way of example, 10% of the image data records presented to him at least twice. In 10% of all the image data records presented, the image data records whose evaluations are known are presented to the respective person for rating for the first time, as a result of which the person's interindividual variability is checked.

In this case, the data processing facility 9 registers the current evaluations of the purposefully added known medical image data records. To asses the quality of the evaluations made by the persons P5 to P8, the sensitivity and the specificity is ascertained for each of the persons P5 to P8 in the case of the present exemplary embodiment. The data processing facility 9 obtains a measure of the sensitivity by using the 20% of known evaluations of image data records to check how many known image data records which explicitly indicate an illness or abnormality are recognized as such by the respective person, with the result that the respective person produces a corresponding finding. The data processing facility 9 obtains a measure of the specificity by using the 20% of known evaluations of image data records to check how many known medical image data records which explicitly do not indicate an illness or abnormality are recognized as such by the person, that is to say the person actually grades image data records indicating healthy tissue, for example, as such. The data processing facility 9 ascertains a dimension both for the sensitivity and for the specificity of each person P5 to P8. In the case of the present exemplary embodiment, a respective percentage is ascertained which is compared with limit values, which are likewise indicated as a percentage, in order to obtain a rating for the qualitative performance of the respective person. In the present case, the limit value is 80% for the sensitivity, i.e. 80% of illnesses which can be recognized from the image data records need to be recognized by the persons P5 to P8. For specificity, the limit value is likewise 80% in the present case, i.e. 80% of image data records which show no illnesses or abnormalities need to be recognized by the persons P5 to P8. These two limit values also do not necessarily need to be firmly prescribed, but rather can be adaptive. On the basis of evaluations made, the limit values can thus vary.

The data processing facility 9 also registers the appliance certification for the appliances 11 to 14 using the PCs 1 to 4, i.e. how long the appliances 11 to 14 may still be used to record image data records before their operation needs to be checked.

In addition, the data processing facility 9 uses the PCs 1 to 8 to register the current availability of the person P1 to 8, the utilization level of the person P1 to P8 and also the utilization level of the appliances used by the persons P1 to 8, that is to say of the PCs to 8 and of the appliances 11 to 14. On the basis of is information, the data processing facility 9 can identify free resources or an imbalance in the utilization level of the persons P1 to P8 and can specifically control the order allocation, be it for the persons P1 to P4 to record image data records or for the persons P5 to P8 to evaluate image data records.

The data processing facility 9 also registers the number of health services processed by the service facility A, B per unit time, in the present case per week, the number of health services processed by the service facilities A, B which resulted in no findings, and the number of health services processed by the service facilities A, B in which medical complications arose. In the case of the present exemplary embodiment, the health service comprises only the recording and evaluation of image data records for the sake of simplicity. In principle, a health service can also comprise other work, however, for example care work or monitoring work. In particular, the medical data records can contain, besides image data, also case history data, data relating to bodily functions, such as blood pressure data, and, besides physical data, also physiological data.

To provide an operator of the health service chain with the opportunity to obtain an overview of the present quantitative and/or qualitative performance of the health service chain overall or else just of one of the service facilities A or B or of parts of the service facilities A or B quickly, the data processing facility 9 constantly, that is to say more or less on line, produces updated graphics relating to the ascertained data, which can be visualized, that is to say displayed on a visual display unit (not shown explicitly) connected to the data processing facility 9, for example. This allows particular information of interest to be selected. To this end, the data processing facility 9 provides a visualization program which can be used to select the data which are to be visualized.

Such a graphic having information which the operator has selected relating to the operation of the health service chain is shown in FIG. 2.

Panel I of the graphic shows the performance quantity for the persons P1, P2, P5 and P6 at the end of a working week. It can thus be seen that person P1 has recorded only four image data records even though 10 image data records needed to be recorded, whereas person P2 has recorded 17 image data records even though 20 recordings needed to be made. Whereas person P5 performed all 50 evaluations of image data records which were asked of him, person P6 achieved only 40 of 50 evaluations which were asked for. It can also be seen that persons P5 to P8 have actually evaluated only 170 of the 200 evaluations of image data records per week which the service facility B asked for. Panel I also shows that medical complications arose in the week for the patients concerned in just two cases out of the 170 cases processed following an evaluations. Such a complication can be an infection, for example. In addition, no findings were produced, that is to say no illness was diagnosed, in 90 of the 170 cases. By way of example, the traffic light illustration for person P5 shows that this person's mean or average processing time per case, that is to say the evaluation of one image data record, was under 3 hours.

A panel II in the graphic shows the performance quantity and the performance quality for persons P3 and P4. It can be seen that person P3 has taken 80% of the recordings of images which were asked of him and person P4 has taken 60% of the recordings of images which were asked of him. The graphic also shows the classification of the image recordings into the four quality levels, with level 1 being the lowest quality level and level 4 being the highest quality level. Accordingly, 95% of the images produced by person P3 are of good to very good quality, while 3% are still adequate and 2% are of rather poor quality. Although persons P4 has clearly not met his stipulations in terms of quantity, he produced images of high quality throughout.

From this partial visualization, it is thus possible to derive, by way of example, the measure for examining the causes of person P3, but particularly person P4, not meeting the stipulations and either for allowing the stipulations or for modifying the ways in which the persons work by training, for example, with person P4 needing to increase performance quality further in order to eliminate the 5% of images of poor quality, and the person needing to maintain the performance quality. In this case, such measures can be proposed (in a manner which is not shown) by the central data processing facility 9, working as an expert system, on the basis of the data available in the data processing facility 9, that is to say on a knowledge basis.

Panel III of the graphic illustrates the analyses for the quality of the evaluations of images by persons P5 and P6. As already explained, the sensitivity and specificity for assessing the quality of the evaluations of the images in the case of the present exemplary embodiment is ascertained for each person P5 to P8. The two columns associated with person P5 show that when checking the intraindividual variability for person P5, sensitivity and specificity are above the 80% stipulation. When checking the interindividual variability, then although the person also achieves a value above 80% for the sensitivity, the value for the specificity is below the 80% stipulation. On the traffic light rating positioned next to the columns, the person is given a red light, the color of which cannot be seen from the black and white graphic, since the stipulations have not been met. Besides the traffic light rating, the average processing time is additionally shown which person P5 needed to evaluate an image. For approximately half of the images, person P5 needed fewer than 3 hours for the evaluation. For approximately one third of the images, person P5 needed more than 4 hours, and for the rest the person needed between 3 and 4 hours. The two columns associated with person P6 show that when checking the intraindividual variability for person P5, sensitivity and specificity are above the 80% stipulation. When checking the interindividual variability, the person achieves a value above 80% for sensitivity, and the value for specificity is precisely at the 80% stipulation. On the traffic light rating positioned next to the columns, the person is given a yellow light, the color of which cannot be seen from the black and white graphic, in order to signal that care is requested on account of the limit case. Besides the traffic light rating, the average processing time which person P6 needed to evaluate an image is also shown for person P6 in addition. For more than half of the images, person P6 needed fewer than 3 hours for evaluation. For approximately one quarter of the images, person P5 needed more than 4 hours, and for the rest the person needed between 3 and 4 hours.

Panel IV of the graphic signals a few consequences which have been derived from the data available in the data processing facility 9. A traffic light representation likewise shows that persons P1 and P5 are barred. The bar on person P5 results from the rating in panel III, since quality stipulations have not been met. Accordingly, person P5 or his PC 5 receives no more image data for evaluation. In the case of the present exemplary embodiment, the bar on person P5 results in person P5 needing to undergo training in order to improve his evaluations of images. This measure derived from the rating is not visualized in the present case but can also be visualized. The consequence of barring person P1 is likewise based on a rating, namely on a rating of the performance quantity for person P1, which has not been visualized explicitly here in panel I of FIG. 2, but is available in the data processing facility 9. For person P1, the data processing facility 9 proposes (in a manner which is not explicitly shown) training relating to work techniques in order to increase the number of image recordings.

Panel IV also reveals that persons P2 and P6, whose performance quantity and performance quality are as intended, remain active for providing the health services.

In addition, panel IV shows monitoring of the appliance certification of the appliance 11. The column representation shows that the appliance continues to be certified until 2003. Accordingly, the traffic light rating for the appliance is green (the color cannot be seen in FIG. 2), which signals that the appliance 11 is enabled.

The present exemplary embodiment shows, by way of example using a health service chain comprising two service facilities, how it is possible to monitor the performance quality and the performance quantity automatically. The invention is not limited to a health service chain comprising two service facilities in this case. Instead, the health service chain can also comprise just one or a plurality of service facilities. The service facilities in the health service chain can in this case be not just image recording and image evaluation centers, as described above, but also registered doctors (house doctors, specialist doctors), clinics, rehabilitation facility or care facilities.

In this case, the telemedical health service to be provided does not necessarily have to relate to the recording and evaluation of image information, but can also relate just to the evaluation of image information. This is the case, for example, when a registered doctor transmits image recordings for evaluation to a specialist using means for remote data transmission. In addition, a telemedical health service can also involve just the recording of image information. This is the case when an image recording facility records image information for a registered doctor, for example, as a result of orders and transmits this information to the doctor using means for remote data transmission. In these cases, the data processing facility accordingly ascertains only quantitative and/or qualitative performance data for the service facilities providing this work.

Instead of ophthalmological images, the health service chain can also be used to record and evaluate mammographical images, pathological images or dermatological images. In addition, the medical data records do not necessarily have to be just image data records. The medical data records can also have other physical data, e.g. blood pressure values, blood sugar values etc., and psychological parameters, previous diagnoses and therapies.

The visualization shown in FIG. 2 for the performance quantity and for the performance quality of persons and the rating thereof and the resultant consequences are likewise to be understood only by way of example. In this case, it is not only possible to record, rate and visualize the parameters described in detail. Rather, as already indicated, it is also possible to register, rate and visualize the availability of the persons P1 to P4 recording medical data records and/or of the persons P5 to P8 evaluating medical data records, the utilization level of the persons P1 to P4 recording medical data records and/or of the persons P5 to P8 evaluating medical data records and/or of the appliances 11 to 14 used by the persons, the number of health services processed by the entire health service chain per unit time, the number of health services processed by the entire health service chain which resulted in no findings, and the number of health services processed by the entire health service chain for which medical complications arose, or just sections thereof.

In this case, the rating does not necessarily need to be made in a traffic light illustration.

The inventive method also makes it possible to produce graphics of similar design for similar or, if expedient, also for different types of service facilities in a health service chain and to compare them with one another in order to compare the performance quantity and/or performance quality, and to derive a rating therefrom. In this regard, the central data processing facility 9 provides all the relevant data, be they technical, of an organizational type, be they of a medical type or be they of an economic type.

Also, the data arising in the course of provision of a telemedical health service do not necessarily need to be analysed just by the central data processing facility 9. Rather, the computers 1 to 8 can also actually make analyses. By way of example, the computes 1 to 4 can actually perform quality examinations on the recorded images, and the computers 5 to 8 can perform quality examinations for evaluating the images.

1. A method for automated monitoring of the quality with which at least one person (P1 to P8), associated with a service facility (A, B) for providing telemedical health services, records and/or evaluates medical data records as part of a telemedical health service and/or for automated monitoring of the performance quantity for the person (P1 to P4) recording the medical data records and/or for the person (P5 to P8) evaluating the medical data records by means of a data processing facility (9), having the following method steps:
a) the number of medical data records recorded per unit time by the person (P1 to P4) recording medical data records and/or the number of medical data records evaluated per unit time by the person (P5 to P8) evaluating medical data records is/are ascertained, and/or data characterizing the quality of the recordings and/or of the evaluation of the medical data records are ascertained,
b) the number of medical data records recorded by the person (P1 to P4) recording medical data records and/or the number of medical data records evaluated by the person (P5 to P8) evaluating medical data records and/or the data characterizing the quality of the recordings and/or of the evaluation is/are compared with stipulations, and
c) the performance quantity and/or the performance quality for the person (P1 to P4) recording medical data records and/or for the person (P5 to P8) evaluating medical data records is/are rated.

2. The method as claimed in claim 1, in which a graphic is produced for visualizing the rating of the performance quantity and/or performance quality for the person (P1 to P4) recording medical data records and/or for the person (P5 to P8) evaluating medical data records.

3. The method as claimed in claim 1 or 2, in which the rating of the performance quantity and/or of the performance quality for the person (P1 to P4) recording medical data records and/or for the person (P5 to P8) evaluating medical data records is taken as a basis for deriving at least one consequence or for proposing a measure.

4. The method as claimed in claim 3, in which the essence of a consequence is that a person (P1 to P4) recording medical data records is assigned no more patients for recording the medical data records.

5. The method as claimed in claim 3 or 4, in which the essence of a consequence is that a person (P5 to P8) evaluating medical data records is allocated no more medical data records.

6. The method as claimed in one of claims 1 to 5, in which the person (P1 to P4) recording medical data records is associated with a first service facility (A) and the person (P5 to P8) evaluating medical data records is associated with a second service facilities (B), which service facilities (A, B) form a health service chain.

7. The method as claimed in one of claims 1 to 6, in which the stipulations for comparing the performance quantity and/or performance quality for the person (P1 to P4) recording medical data records and/or for the person (P5 to P8) evaluating medical data records are adaptive.

8. The method as claimed in one of claims 6 or 7, in which at least some of the service facilities (A, B) in the health service chain are arranged at different locations, with the data which are produced in the service facilities (A, B) and are stored in computers (1 to 8) in the service facilities (A, B) being compiled in a central data processing facility (9).

9. The method as claimed in claim 8, in which the computers (1 to 8) in the service facilities (A, B) are networked to one another and to the central data processing facility (9).

10. The method as claimed in one of claims 1 to 9, in which the average processing time for a data record from a person (P1 to P4) recording medical data records and/or from a person (P5 to P8) evaluating medical data records is ascertained.

11. The method as claimed in one of claims 1 to 10, in which the quality of the evaluation of medical data records by the person (P5 to P8) evaluating medical data records is ascertained on the basis of the following method steps:
a) known medical data records which relate to telemedical health services and whose evaluation is known are added purposefully to medical data records awaiting evaluation,
b) the present evaluations of the purposefully added known medical data records are registered,
c) the present evaluations of the known medical data records are compared with the known evaluation of the known medical data records, and
d) the number of present evaluations which differ significantly from the known evaluations of the known medical data records is ascertained.

12. The method as claimed in claim 11, in which the known evaluations of the known medical data records come from the person (P5 to P8) evaluating the medical data records himself.

13. The method as claimed in claim 11 or 12, in which the known evaluations of the known medical data records from the person (P5 to P8) evaluating medical data records are presented for the first time.

14. The method as claimed in one of claims 11 to 13, in which the known medical data records are used to check how many known medical data records which explicitly indicate an illness or abnormality are recognized as such by the person (P5 to P5) evaluating medical data records.

15. The method as claimed in one of claims 11 to 14, in which the known medical data records are used to check how many known medical data records which explicitly do not indicate an illness or abnormality are recognized as such by the person (P5 to P8).

16. The method as claimed in one of claims 1 to 15, in which it is checked how long a medical appliances (11 to 14) used by a service facility (A, B) is licensed for telemedical health services before its operation needs to be checked.

17. The method as claimed in claim 16, in which the status is signalled in relation to the checking of the appliance (11 to 14).

18. The method as claimed in claim 16 or 17, in which the medical appliance (11 to 14) is disabled when the time for the operating licence of the appliance (11 to 14) has been exceeded.

19. The method as claimed in one of claims 1 to 18, in which the medical data records are image data.

20. The method as claimed in claim 19, in which the image data are ophthalmological image data, mammographical image data, pathological image data or dermatological image data.

21. The method as claimed in one of claims 1 to 20, in which the availability of the person (P1 to P4) recording medical data records and/or of the person (P5 to P8) evaluating medical data records is registered.

22. The method as claimed in one of claims 1 to 21, in which the utilization level of the person (P1 to P4) recording medical data records and/or of the person (P5 to P8) evaluating medical data records and/or of the appliances (1 to 8, 11 to 14) used by the persons (P1 to P8) is registered.

23. The method as claimed in one of claims 1 to 22, in which the number of health services processed per unit time is registered.

24. The method as claimed in one of claims 1 to 23, in which the number of health services processed which provided no findings is registered.

25. The method as claimed in one of claims 1 to 24, in which the number of health services processed in which medical complications arose is registered.
